(19) United States
(12) Patent Application Publication
(10) Pub. No.: US 2010/0072195 A1
(43) Pub. Date: Mar. 25, 2010

(54) COMPACT DESICCATING MICROWAVE OVEN FOR WATER REMOVAL BY AEROSOL FORMATION

(75) Inventor: William J. ALTON, Nashua, NH (US)

Correspondence Address: DYKAS, SHAVER & NIPPER, LLP, P.O. BOX 877, BOISE, ID, 83701-0877, US

(73) Assignee: The Ferrite Company, Inc., Nashua, NH (US)

(21) Appl. No.: 12/571,164

(22) Filed: Sep. 30, 2009

Related U.S. Application Data
(63) Continuation-in-part of application No. 12/488,283, filed on Jun. 19, 2009.
(60) Provisional application No. 61/074,054, filed on Jun. 19, 2008.

(51) Int. Cl. H05B 6/70; H05B 6/64

(52) U.S. Cl. 219/690; 219/757

(57) ABSTRACT

A microwave based dewatering device utilizing circularly polarized TE₁₁ microwave energy (spinning), a reflecting image plane, and a belt with product, with microwave energy forming an aerosol creation zone for water removal.

### CROSS-REFERENCE TO RELATED APPLICATIONS

This application is a continuation-in-part application of application Ser. No. 12/433,283 filed Jun. 19, 2009, entitled Apparatus and Method for Microwave-Based De-watering of Process Substrates Using High Wave Impedance Electric Fields, which is a non-provisional application of expired provisional application Ser. No. 61/074,054 filed on Jun. 19, 2008.

### FIELD OF THE INVENTION

The invention generally relates to an apparatus for de-watering of materials and more particularly to a microwave-based de-watering system.

### BACKGROUND OF THE INVENTION

There are a number of situations in which various types of substrates need to have water removed from them in order to create a product or to move to the next step in creating a product. Examples of these substances can include bio solids and sludge from treatment plants, distiller's grains, and food processing materials from which juice has already been squeezed, such as apple pomace, grape squeezings after juice removal, and many other materials from which water must be removed to prepare the material for further use.

A number of different heating processes have been utilized in these situations including, directing heated air at the materials, vacuum ovens, infrared heat, and using microwave energy to drive off water in a boiling process.

When microwave energy is used for this purpose, it is used in a manner which causes water molecules in the substrate to be heated to the point of boiling, and to exit the substrate as water vapor. Water vapor is a gaseous form of water, and is invisible to the eye. Since water has a very high latent heat, a tremendous amount of energy is required to cause a phase change of the water from liquid to gaseous. It is for this reason that microwave energy is not often utilized to change a product from a wet state to a dry state. Using microwave energy would also have the side effect of heating the substrate, and it might be better for the substrate to not rise to the temperature of boiling water.

Microwaves can be generated from a number of sources. Microwave sources that are used for heat generation are tube based and include klystrons, magnetrons, and gyrotrons. These devices generate bunching of electrons which induce high frequency electromagnetic waves, or microwaves. Microwaves, like all electromagnetic radiation, have electrical fields that vary between positive and negative values of electromagnetic force. A microwave focused on a particular point in space applies an oscillating, positive and negative electromagnetic force.

Water molecules have inherent characteristics that cause them to behave in a specific manner when exposed to microwave radiation. Water molecules have what is called a dipole. The water molecule composed of two hydrogen atoms and a single oxygen atom has a well defined positive-negative dipole, much like a magnet. The oxygen atom has a partial negative charge, and the two hydrogen atoms to one side of the oxygen atom have a partial positive charge. When the dipole of a water molecule is exposed to the rapid alteration of positive and negative electromagnetic fields from a microwave, the water molecule is caused to rapidly rotate to align with the field. The rotation of a single water molecule causes it to bump into other water molecules, generating friction and heat. The heat generated is eventually sufficient to cause the vaporization of the water by boiling.

Microwaves are not usually considered to be the optimum method for pure thermal de-watering applications. This is largely due to inefficiencies encountered when converting ordinary electricity to microwave power and then applying that power to the material to be dried. It takes a lot of energy to cause a phase change in water from liquid to vapor. However, in many circumstances, microwave de-watering has many advantages over straight thermal water extraction.

Microwave ovens are used for a wide range of industrial applications. For processing large quantities of product, the most common type of microwave oven is of the multimode type. Multiple transmitters supply microwave energy to large metal boxes, which are often joined in series to allow material to be transported through them and give increased processed throughput.

A problem, which existed previously with uniformity of heating and/or drying of processed product, was solved by introducing circularly polarized microwave energy spinning at the frequency of the microwave (915 million times per second for 915 MHz). This maximizes the number of microwave modes generated in the multimode oven. (U.S. Pat. Nos. 6,034,362 and 6,274,858 B1).

For drying with multimode cavities being supplied with spinning microwave energy, when careful data was taken of BTU's supplied from microwave and hot air, and the amount of water removed, it was evident that some mechanism was taking place to remove water without the need to heat it from room temperature to boiling and then supply energy to turn it to steam. Inspection through view ports confirmed that water was coming out of the product as an aerosol, which accounted for the lower energy used.

There is a need for a highly efficient, microwave-based, de-watering apparatus and process that uses high intensity microwave electric fields to remove water by forming an aerosol. This need is due to inherent advantages over conventional thermal de-watering processes such as the volumetric heating profiles present with microwave heating. Also, instead of dislodging the entrapped water molecules through purely thermal means, the microwave aerosol de-watering process causes water molecules to be forced from their entrapped positions by the applied oscillating electric fields alone. Depending on the specifics of how the water molecules are entrapped in a given material and the heat of adsorption of that material, an aerosol forming microwave process may be more efficient than a purely thermal process where water molecules are driven out of the material by vaporization. A purely thermal process requires an amount of energy equal to the latent heat of vaporization of the water to be removed.

There is a need for an aerosol forming microwave-based de-watering apparatus and process that is highly efficient and uses less energy than required by conventional thermal processes and equipment.

Based on the efficiency of the multimode cavities with TE₁₁ mode microwave, an oven was created using an image plane positioned below a belt containing product, with the image plane reflecting microwave energy after it has passed through the product, and using the reflected energy in an amplifying effect to form a high impedance plane within the product, to form a zone of aerosol formation. This approach results in maximum efficiency, and allows the microwave oven to be sized as much as 80% smaller in volume than multimode microwave ovens.

The purpose of the Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### SUMMARY OF THE INVENTION

The present invention is a technique for maximizing the effect of a circularly polarized microwave signal, and provides a microwave oven up to 80% more compact than previous technologies, in which a layer of product is spread on a belt for drying.

Microwave energy is fed from transmitters through rectangular waveguide sections to multiple microwave emitters, called feeds. Each feed has directional couplers and a microwave tuner in rectangular guide to enable minimization of reflected (unused) energy. The simplest form of rectangular to circularly polarized feed (U.S. Pat. No. 6,034,363) is preferred. Each circular polarized feed is attached to a hole in the roof of the microwave unit and launches its energy downward from there onto a belt with product to be dried.

The product on its belt is close to the roof apertures and is in the near field of the microwave. The near field of the microwave is the region close to the radiating structure where the energy has not yet started to substantially spread radially to a greater diameter than the radiating aperture. The product thickness is chosen based on its loss characteristics so that there is sufficient energy passing through the product to provide a meaningfully high impedance from the downward traveling energy and the upward traveling reflected energy. The spacing of the reflecting surface from the product is also based on the dielectric characteristics of the product. The high impedance point (maximum voltage) is one-quarter wavelength from the reflecting surface, which includes distance in air and in the product to provide maximum intensity within the product. When these dimensions are optimized, a high impedance plane is formed which is coincident with a zone of aerosol formation in the product layer.

### BRIEF DESCRIPTION OF THE DRAWINGS

FIG. 1 is a partial perspective view of a single belt continuous feed type oven that makes use of circularly polarized feeds and a reflecting plane according to the invention.

FIG. 2 is a longitudinal cross-section of the oven of FIG. 1 showing internal details of the image (reflecting plane, belt support and spacing, and product).

FIG. 3 is a transverse cross-section of the oven of FIG. 1 showing width details of the internal structure and of the product.

### DESCRIPTION OF THE PREFERRED EMBODIMENTS

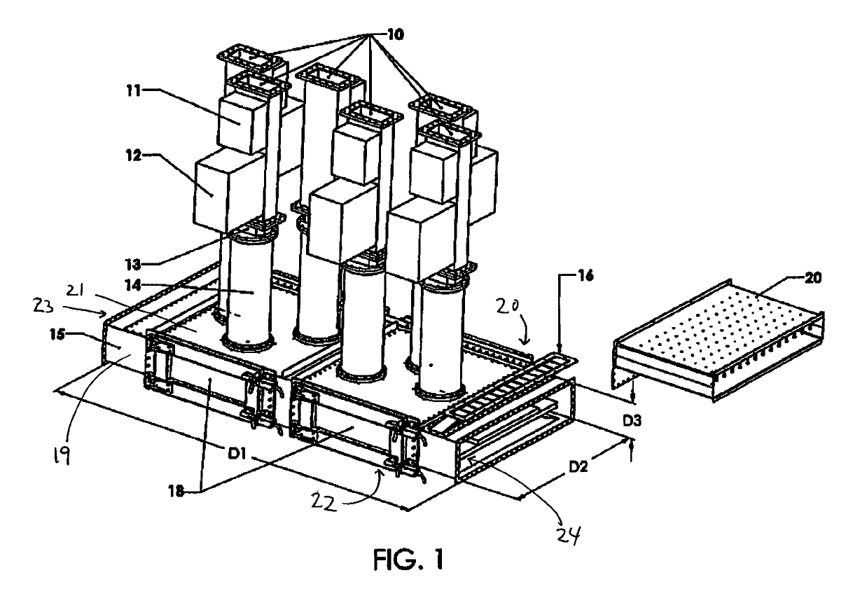

The invention is shown to advantage in FIGS. 1 through 3. FIG. 1 shows a microwave oven 15 which makes us of an array of circularly polarized applicators, also called feeds 10, to illuminate with microwaves the product on a belt passing through the unit. The microwave oven 15 has a left side 19, a right side 20, a top side 21, and bottom side 22, an entry passage 23, and exit passage 24. Each feed 10 passes through the top side 21 of the microwave oven 15, through microwave passages 36 which allow microwave energy to illuminate the belt 33 directly below the microwave passages 36.

Each individual microwave feed 10 includes an input rectangular waveguide 13, and couplers 11 to measure the forward and reflected power. A tuner section 12 is used to generate offsetting microwave reflections, which cancel and negate the reflections generated within the applicator from impedance differences of microwaves in air and in the product, any energy not fully absorbed in the product and at rectangular to circularly polarized transitions.

For systems which will only process one product, manually adjusted tuning at initial system setup is the simplest approach. For systems to be used for a variety of applications, a computer controlled tuning as described by Harris, et al. (U.S. Pat. Nos. 5,756,975 and 5,892,208) is the most convenient approach.

The tuning section in rectangular waveguide is followed by 13, a rectangular to round waveguide transition, and 14, a circulator waveguide section with an asymmetrical element (U.S. Pat. No. 6,034,362) which creates a circularly polarized wave.

Since the product will typically be of the order of 1-2 inches thick spread on the conveyor belt for high-moisture content products, leakage suppression is easily achieved by having the belt and product enter and leave the microwave chamber through a resonant pin-choke array 20. This has been standard in industrial processing for many decades.

Each individual feed will radiate a microwave power level based on the loss, or moisture level in the product at that point. An oven 15 may be joined to adjacent ovens 15, to form a longer processing unit. Thus, if the oven 15 is at the input of a multi-oven sludge line with high moisture content, each of the six feeds may have 50 kw input power at 915 MHz. Later ovens will radiate reduced microwave power levels and a final oven will typically have 20 kw per feed. Since each feed is illuminating the product with near field radiation, this is essentially single mode operation, and the product has the microwave beam shining onto its surface like a flashlight. Near field radiation means the radiation within the region close to the radiating structure where the microwave energy is still mainly propagating forward, and has not yet developed a large radial motion. Single mode operation refers to microwave propagation in a metal tube where the frequency of operation is close to the condition where much lowering of the frequency will not be possible because the tube will be too small for that frequency. Single mode has a clearly defined energy pattern, which is not maintained for multi-mode ovens. The array of feeds 10 is set up to give uniform microwave application across the desired width of product on the belt.

Typical dimensions for an oven of this type at 915 MHz are oven length D1 of 106 inches width of 44 inches. The width is usually based on the mechanical handling equipment used to uniformly spread the product on the belt. Since each microwave feed is operating as a single mode independent of the other feeds, there is no microwave restriction on the width of product to be processed. A wider product would merely require more feeds in the width direction to maintain uniform illumination of the product.

The device can operate at 915 MHz, or 896 MHz, or 922 MHz, which are approved frequencies which can use almost identical equipment. It can also operate at 406 MHz, as well as 2450 MHz.

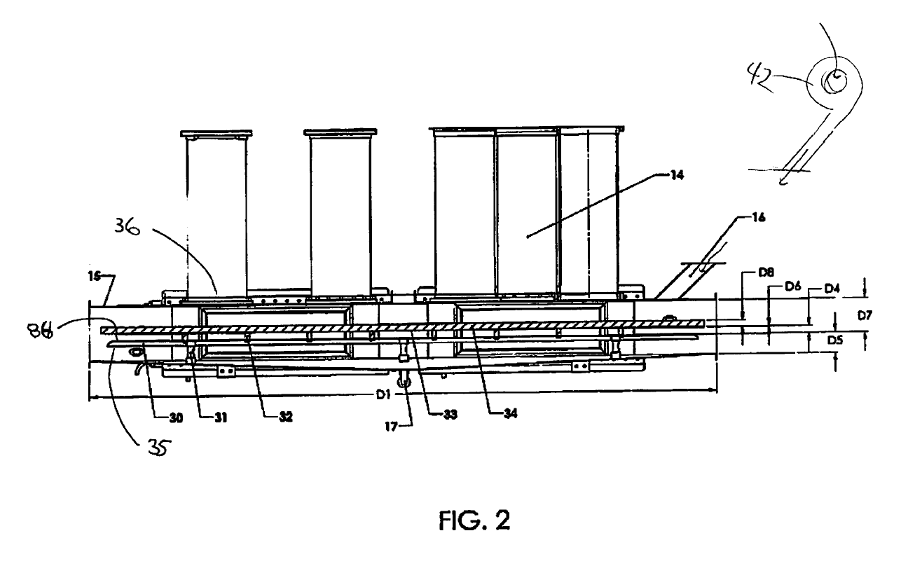

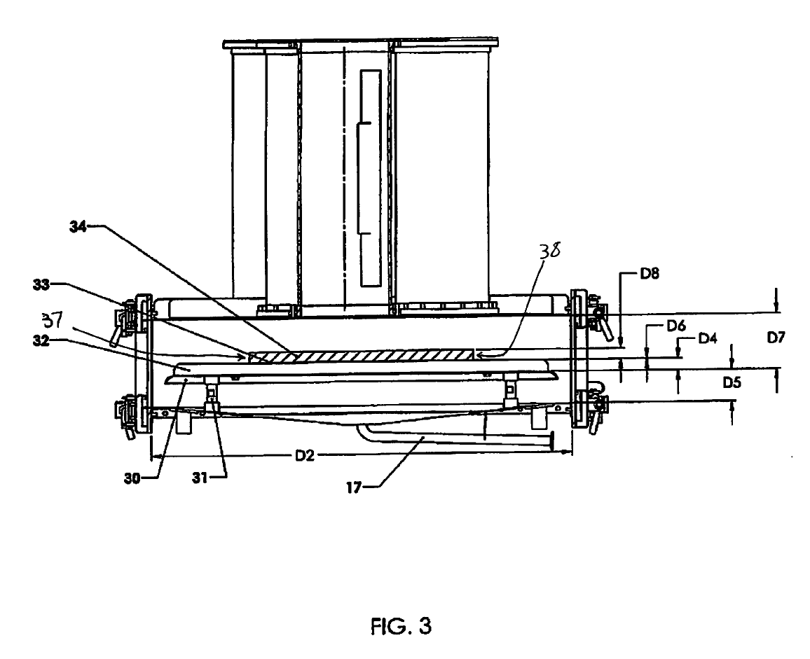

FIG. 2 is a longitudinal cross-section of an oven and FIG. 3 is a transverse cross-section with all internal parts and product in place.

The microwave oven 15 serves as a ground path only, since the microwave is confined to the volume between the circularly polarized feed 10, and the reflecting plane 30. The reflecting plane 30 (also called an image plane) is attached to the microwave oven 15 by metal supports 31, which completes the grounding of plane 30. The reflecting plane can also be formed from the bottom side of the oven itself.

Belt supports 32 are plastic bars (typically Teflon) attached to the plane 30 using plastic bolts. These bars are sized to support the belt 33 at a position which puts the interior of the product 34 at the highest impedance point of the wave, resulting from the forward and reflected microwaves. This impedance plane 37 forms a zone of aerosol formation within the product, where water from the product is turned into an aerosol.

To ensure that the microwave radiated towards the product and image (reflecting) plane remains single mode, the distances from radiating aperture to product and reflector are kept at less than the diameter of the radiating aperture. At 915 MHz this results in typical dimensions of distance to the reflector D7 of 6 inches and reflector to belt spacing of 1.25 inches. The belt 33 is normally a Teflon-coated glass fiber web and is very thin with D6 around 0.03 inches. For a high moisture content material to be processed, the thickness D8 will be typically 1.2 inches. The wavelength for the reflector to peak voltage (high impedance) is one quarter wavelength. At 915 MHz, the wavelength in air is 12.9 inches and in a dielectric material is reduced by the square root of the dielectric constant. For water at 915 MHz the dielectric constant is approximately 80, and the depth at which power is reduced to 1/e (37%) of incident is 1.6 inches. For high water content material, the wavelength will be reduced to the order of 2 inches. The high impedance plane will be spaced 1.25 inches (0.097λ) in air plus 0.153λ in product of λ of 2 inches. This means the high impedance plane will be 0.3 inches above the belt and will move higher as the product moves through the ovens and is dried.

D3 is the internal height of the oven (equal to D5 plus D7) and does not include the sloped drainage portion. D3 would typically be 9.5 inches.

D4 is the height of the top of the belt from the image plane, and would typically be 1.25 inches.

D5 is the height of the image wave reflecting surface from the flat outer edge of the inside of the oven base, which does not include the sloped drainage portion, and would typically be 3.5 inches.

This oven has a distance from the launch plane of the microwaves (the feeds 10) in the top side 21 of the microwave oven 15 to the reflecting plane 31 of less than or equal the diameter of the circular waveguide to maintain single mode near-field characteristics. Single mode near-field means propagation similar to that in a metal tube where the frequency of operation is close to the condition where much lowering of the frequency will not be possible because the tube will be too small for that frequency. Single mode has a clearly defined energy pattern, which is not maintained for multi-mode ovens and the near field means the radiation within the region close to the radiating structure where the microwave energy is still mainly propagating forward, and has not yet developed a large radial motion.

A circular waveguide section 14 is typically 9.5 inches in diameter, which allows D7 to be 6.0 inches in height. The microwave oven of the invention if preferably made of aluminum with the image plane 30 preferably made of stainless steel. The airflow generator 42 can be a fan blowing approximately 4,500 cfm of air into the interior of the microwave oven 15, for a four oven system in series.

Another aspect of the invention is the use of hot air passed through the oven which enhances the efficiency by sweeping away the aerosol of water droplets driven from the product. It also provides an osmotic gradient by keeping the surface dry which aids water movement from the interior to the surface. The optimum amount of hot air is in the region of 25% of the BTU's supplied by the microwave for high moisture product. The efficiency can be further improved by passing the exhaust hot air through a heat exchanger for the inlet air or some other form of energy recapture. Item 16 in FIG. 1 and FIG. 2 is a typical air inlet/outlet for allowing air flow in or out from connected ducting with multiple small apertures which prevent microwave leakage.

Other items are added to the oven to ease cleaning and maintenance. In FIG. 1, items 13 are two removable doors which seal the microwave in when clamped, but are readily removable for cleaning.

The outer shell has a sloped floor and a drainage pipe 17. This is sized to prevent any leakage of microwave energy but prevents any water guild up during operation, and is necessary for drainage when cleaning by hosing the interior.

Circularly polarized TE₁₁ microwave energy (spinning) is used to illuminate material to be processed in the near field of the aperture where the single mode of the waveguide feed is maintained. This, in conjunction with a reflecting surface, and when feeding the microwave from only one side allows a very compact processing container which is 20% or less than the size of a multi-mode microwave applicator. Adjustment of the distance from the reflecting plane to the interior of the material being processed or de-watered is optimized, based on the dielectric properties of the material, to ensure the peak in forward and reflected voltage (high wave impedance region) occurs within the material. Plastic bars, typically Teflon or polypropylene, are sized to support the belt and give the correct spacing between the reflecting surface and the belt, to place the high wave impedance in the product being processed.

Hot air supplied to the processing chamber (15-30% of the BTU supplied by the microwave) enhances the efficiency of the drying process.

Equivalents

While this invention has been particularly shown and described with references to preferred embodiments thereof, it will be understood by those skilled in the art that various changes in form and details may be made therein without departing from the spirit and scope of the invention as defined by the appended claim. For example, the circularly polarized TEₙ wave required can be achieved by a large number of waveguide means to provide the desired asymmetry and resulting spinning wave. In addition, this approach of near-field microwaves and a reflecting surface to enhance the heating and/or dewatering is suitable for both batch and continuous processing systems. Those skilled in the art will recognize or be able to ascertain using no more than routine experimentation, many equivalents of the invention described specifically herein. Such equivalents are intended to be encompassed in the scope of the claims.

What is claimed is:

1. A desiccating microwave oven for water removal by aerosol formation, comprising:
a generally rectangular microwave oven with a left side, a right side, a bottom side, and a top side, and an entry passage, and an exit passage, with said microwave oven made of a microwave reflecting material;
an image plane in said microwave oven, having a top and a bottom surface, said image plane made of a microwave reflecting material and with said top surface configured for reflecting microwave energy directed from said oven top onto said top surface of said image plane;
a plurality of circularly polarized microwave TE₁₁ feeds attached to said top side of said oven, with said oven top side defining a microwave passage for each TE₁₁ feed, with each TE₁₁ feed comprising a circular waveguide section, a rectangular to round waveguide transition, a microwave source, and a tuner section to negate reflected microwave energy;
a product belt positioned above said image plane at a height so that energy from said microwave feeds and reflected energy from said image plane creates a high impedance plane within the volume of a product on said product belt, with said high impedance region forming at one quarter wavelength from said image plane, and forming a zone of aerosol formation within said product;
an air transport system with an entry duct into said oven with microwave blocking air vents, an exit duct from said oven with microwave blocking air vents, and an airflow generator, with said air transport system configured to move air through said oven in order to remove aerosol moisture from said product;
with said microwave oven configured with a reduced oven height between said bottom side and said top side, with said oven height being less than 130% of the diameter of said circular waveguide section.

2. The desiccating microwave oven of claim 1 in which said oven height is less than or equal to the width of the diameter of said circular waveguide section.

3. The desiccating microwave oven of claim 1 which further comprises at least one belt support made of a microwave insulating material, with said belt support configured to position a product within an impedance plane of said microwave.

4. The desiccating microwave oven of claim 1 in which said image plane is electrically connected to and spaced from the oven bottom side by metallic standoffs.

5. The desiccating microwave oven of claim 1 in which said image plane is an inner surface of said bottom side of said oven.

6. The desiccating microwave oven of claim 1 in which said oven bottom side further comprises angled surfaces and a microwave cutoff tube for drainage of liquid from an interior of said oven.

7. A desiccating microwave oven for water removal by aerosol formation, comprising:
a generally rectangular microwave oven with a left side, a right side, a bottom side, and a top side, and an entry passage, and an exit passage, with said microwave oven made of a microwave reflecting material;
an image plane in said microwave oven, having a top and a bottom surface, said image plane made of a microwave reflecting material and with said top surface configured for reflecting microwave energy directed from said oven top onto said top surface of said image plane;
a plurality of circularly polarized microwave TE₁₁ feeds attached to said top side of said oven, with said oven top side defining a microwave passage for each TE₁₁ feed, with each TE₁₁ feed comprising a circular waveguide section, a rectangular to round waveguide transition, a microwave source, and a tuner section to negate reflected microwave energy;
a product belt positioned above said image plane by at least one belt support made of a microwave insulating material, with said belt support configured to position a product at a height so that energy from said microwave feeds and reflected energy from said image plane create a high impedance plane within the volume of a product on said product belt, with said high impedance region forming at one quarter wavelength from said image plane, and forming a zone of aerosol formation within said product;
an air transport system with an entry duct into said oven with microwave blocking air vents, an exit duct from said oven with microwave blocking air vents, and an airflow generator, with said air transport system configured to move air through said oven in order to remove aerosol moisture from said product;
with said microwave oven configured with a reduced oven height between said bottom side and said top side, with said oven height being less than or equal to the diameter of said circular waveguide section.
